(19) United States
(12) Patent Application Publication
(10) Pub. No.: US 2006/0274254 A1
(43) Pub. Date: Dec. 7, 2006

(54) Liquid crystal display device having photospacers overlapping data lines

(76) Inventor: Shuo-Ting Yan, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 11/446,695

(22) Filed: Jun. 5, 2006

(30) Foreign Application Priority Data
Jun. 3, 2005 (TW) 94118396

(51) Int. Cl. G02F 1/1339

(52) U.S. Cl. 349/155

(57) ABSTRACT

An exemplary liquid crystal display device (3) includes a first substrate (31), a second substrate (32) opposite to the first substrate, and a liquid crystal layer (34) disposed between the first and second substrates. A number of data lines (322) is disposed on the first substrate. A number of photospacers (36) is disposed on one of the first and second substrates, and the photospacer is disposed over a corresponding one of the data lines and at least partly overlies the corresponding data line. The photospacer has a lower dielectric constant than the liquid crystal layer. Thus, the liquid crystal display device has a lower coupling capacitance between the data lines and other elements. This facilitates a reduction crosstalk during operation of the liquid crystal display device, so that the liquid crystal display can provide better quality images.

### FIELD OF THE INVENTION

The present invention relates to liquid crystal display (LCD) devices, and particularly to a liquid crystal display device having photospacers overlapping data lines in order to minimize crosstalk.

### BACKGROUND

Because liquid crystal display devices have the merits of being thin, light in weight, and drivable by a low voltage, they are extensively employed in various electronic devices. A typical LCD device 1 as shown in FIG. 8 includes a first substrate 11, a second substrate 12, and a liquid crystal layer 13 interposed between the first and second substrates 11, 12. The first substrate 11 has a color filter 15 formed thereon, the color filter 15 being adjacent the liquid crystal layer 13. A plurality of spacers 14 is arranged between the first and second substrates 11, 12. The spacers 14 are used for supporting and separating the first substrate 11 and the second substrate 12. Generally, the spacers 14 are made of glass or plastic, and are randomly sprayed between the first and second substrates 11, 12 by a spreading device during manufacture. This may result in diffractions, a reduction in the contrast ratio, and uneven load distribution among the spacers 14 of the LCD device 1.

To solve the difficulties of the LCD device 1, another kind of LCD device 2 as shown in FIG. 9 was developed. The LCD device 2 includes a first substrate 21, a second substrate 22, and a liquid crystal layer 23 having a plurality of liquid crystal molecules interposed between the first and second substrates 21, 22. A black matrix 25 is formed on an underside of the first substrate 21. A color filter 26 is arranged on the first substrate 21 and the black matrix 25. A protection layer 241 and an indium tin oxide (ITO) layer 240 are arranged on the above-described structure, in that order from top to bottom. The ITO layer 240 is adjacent the liquid crystal layer 23. A plurality of photospacers 24 is arranged between the first and second substrates 21, 22. The first substrate 21, the second substrate 22, and the photospacers 24 cooperatively define a plurality of separate spaces to accommodate the liquid crystal molecules. The photospacers 24 are transparent, and locations of the photospacers 24 are predetermined.

Because the locations of the photospacers 24 are predetermined, the photospacers 24 can uniformly separate the first and second substrates 21, 22 and increase a contrast ratio and a mechanical strength of the LCD device 2. However, generally, the LCD device 2 has a large size and a high resolution. Thus a multiplicity of pixel electrodes, data lines, gate lines and the like are needed, and are arranged densely at the second substrate 22. In operation of the LCD device 2, these elements transmit numerous different electrical signals. Neighboring signals that are very close to each other and are transmitted at high frequencies are liable to interfere with each other, which disturbance is commonly called crosstalk. Crosstalk may result in errors in signals transmission, and the display performance of the LCD device 2 may thereby be degraded.

What is needed, therefore, is an LCD device which has a good contrast ratio and which can reduce crosstalk and facilitate good display performance.

### SUMMARY

A liquid crystal display device includes a first substrate having a plurality of data lines thereon, a second substrate opposite to the first substrate, and a liquid crystal layer interposed between the first and second substrates. A plurality of photospacers is provided between the first and second substrates to support and separate the first and second substrates. The photospacers have a lower dielectric constant than the liquid crystal layer. At least one of the photospacers is disposed over a corresponding one of the data lines and at least partly overlies the corresponding data line.

In the liquid crystal display device, the plurality of photospacers is provided between the first and second substrates to support and separate the first and second substrates. The liquid crystal display device can increase a contrast ratio and a mechanical strength of the LCD device. Further, at least one of the photospacers is disposed over one of the data lines and overlaps at least one part of the data lines, and the photospacers have a lower dielectric constant than the liquid crystal layer. Accordingly, the corresponding photospacer at least partly overlying the corresponding data lines can reduce a dielectric constant of a capacitance of any coupling capacitor between the data lines and other elements. Thus, the liquid crystal display device has a lower coupling capacitance between the data lines and other elements. This facilitates a reduction crosstalk during operation of the liquid crystal display device, so that the liquid crystal display can provide better quality images.

Other advantages and novel features of various embodiments will become more apparent from the following detailed description when taken in conjunction with the accompanying drawings.

### BRIEF DESCRIPTION OF THE DRAWINGS

FIG. 1 is a schematic, cross-sectional view of part of a liquid crystal display device according to a first embodiment of the present invention.

FIG. 2 is a chart illustrating changes in capacitance of a first coupling capacitor that includes a data line and a pixel electrode of the liquid crystal display device of FIG. 1, such changes occurring according to changes in a dielectric constant of a photospacer of a dielectric layer of the first coupling capacitor.

FIG. 3 is a chart illustrating changes in capacitance of a second coupling capacitor that includes a data line and a common electrode of the liquid crystal display device of FIG. 1, such changes occurring according to changes in a dielectric constant of a photospacer of a dielectric layer of the second coupling capacitor.

FIG. 4 is a schematic, cross-sectional view of part of a liquid crystal display device according to a second embodiment of the present invention.

FIG. 5 is a chart illustrating changes in capacitance of a first coupling capacitor that includes a data line and a pixel electrode of the liquid crystal display device of FIG. 4, such changes occurring according to changes in a dielectric constant of a photospacer of a dielectric layer of the first coupling capacitor.

FIG. 6 is a chart illustrating changes in capacitance of a second coupling capacitor of a data line and a common electrode of the liquid crystal display device of FIG. 4, such changes occurring according to changes in a dielectric constant of a photospacer of a dielectric layer of the second coupling capacitor.

FIG. 7 is a schematic, cross-sectional view of part of a liquid crystal display device according to a third embodiment of the present invention.

FIG. 8 is a schematic, cross-sectional view of part of a conventional liquid crystal display device.

FIG. 9 is a schematic, cross-sectional view of part of another conventional liquid crystal display device.

### DETAILED DESCRIPTION OF PREFERRED EMBODIMENTS

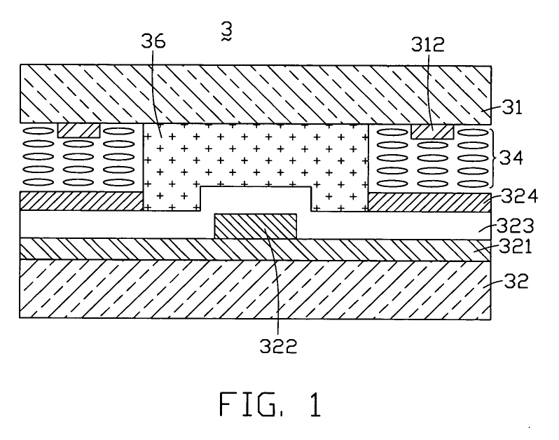

Referring to FIG. 1, this shows part of an LCD device 3 according to the first embodiment of the present invention. The LCD device 3 includes a first substrate 31, a second substrate 32, and a liquid crystal layer 33 interposed between the first and second substrates 31, 32. The second substrate 32 has an insulating layer 321, a plurality of data lines 322 (only one shown), a passivation layer 323, and a plurality of pixel electrodes 324 provided thereon. Each data line 322 is disposed generally between two nearest pixel electrodes 324. The first substrate 31 has a plurality of photospacers 36 and common electrodes 312 provided thereon. There is a space between each two adjacent common electrodes 312. The photospacers 36 support and separate the first and second substrates 31, 32. Thus the first substrate 31, the second substrate 32 and the photospacers 36 may cooperatively define a plurality of separate spaces to accommodate liquid crystal molecules of the liquid crystal layer 33 therein. Each photospacer 36 is disposed above and overlies a corresponding one of the data lines 322. Preferably, each photospacer 36 completely overlies the corresponding data line 322.

Any one of the data lines 322, one of the two corresponding pixel electrodes 324, the passivation layer 323, and the corresponding photospacer 36 may define a first coupling capacitor. The passivation layer 323 and the corresponding photospacer 36 arranged between the data line 322 and the corresponding pixel electrode 324 act as a dielectric layer of the first coupling capacitor. Further, any one of the data lines 322, one of two corresponding common electrodes 312, the passivation layer 323 and the corresponding photospacer 36 may define a second coupling capacitor. The passivation layer 323 and the corresponding photospacer 36 arranged between the common electrode 312 and the data line 322 act as a dielectric layer of the second coupling capacitor.

In operation of the LCD device 3, different voltages may be applied on the pixel electrodes 324 and the data lines 322. Thus a parasitic electric field may be generated between any one of the pixel electrodes 324 and a corresponding data line 322. The parasitic electric field may adversely influence a display performance of the LCD device 3. Similarly, different voltages may be applied on the common electrodes 312 and the data lines 322. Thus a parasitic electric field may be also generated between any one of the common electrodes 312 and a corresponding data line 322. The parasitic electric field may adversely influence the display performance of the LCD device 3.

A formula describing capacitance of a capacitor is:

$$C = \frac{ɛ \cdot A}{d} \qquad ( 1 )$$

In formula (1), C denotes a capacitance of the capacitor. ε denotes a dielectric constant of the dielectric layer, such as one photospacer 36 combined with the passivation layer 323. A denotes an effective area of the capacitor. d denotes a distance between two electrodes of the capacitor. Such distance may be that between one pixel electrode 324 and a corresponding data line 322, or that between one common electrode 312 and a corresponding data line 322. The capacitance C is directly proportional to the dielectric constant ε and the effective area A, and is inversely proportional to the distance d. Thus, when the distance d and the effective area A are determined, the capacitance C may be changed by changing the dielectric constant ε.

As described above, the first substrate 31, the second substrate 32 and the photospacers 36 may define a plurality of separate spaces to accommodate the liquid crystal molecules. That is, the locations of the photospacers 36 are predetermined. Therefore the photospacers 24 can uniformly separate the first and second substrates 21, 22, and increase a contrast ratio and a mechanical strength of the LCD device 3.

Further, the passivation layer 323 and the corresponding photospacer 36 arranged between the corresponding pixel electrode 324 and any one data line 322 act as the dielectric layer of the first coupling capacitor. The photospacers 36 are configured to have a lower dielectric constant than a dielectric constant of the liquid crystal layer 33. Accordingly, the corresponding photospacer 36 arranged between the corresponding pixel electrode 324 and the data line 322 can reduce the dielectric constant of the dielectric layer of the first coupling capacitor. Thus, the liquid crystal display device 3 has a lower first coupling capacitance between the data lines 322 and the pixel electrodes 324. This facilitates a reduction in crosstalk during operation of the LCD device 3, so that the LCD device 3 can provide better quality images.

Similarly, the passivation layer 323 and the corresponding photospacer 36 arranged between the corresponding common electrode 312 and any one data line 322 act as the dielectric layer of the second coupling capacitor. The photospacers 36 have the lower dielectric constant compared with the dielectric constant of the liquid crystal layer 33. Accordingly, the corresponding photospacer 36 arranged between the corresponding common electrode 312 and the data line 322 can reduce the dielectric constant of the dielectric layer of the second coupling capacitor. Thus, the LCD device 3 has a lower second coupling capacitance between the data lines 322 and the common electrodes 312. This facilitates a reduction in crosstalk during operation of the LCD device 3, so that the LCD device 3 can provide better quality images.

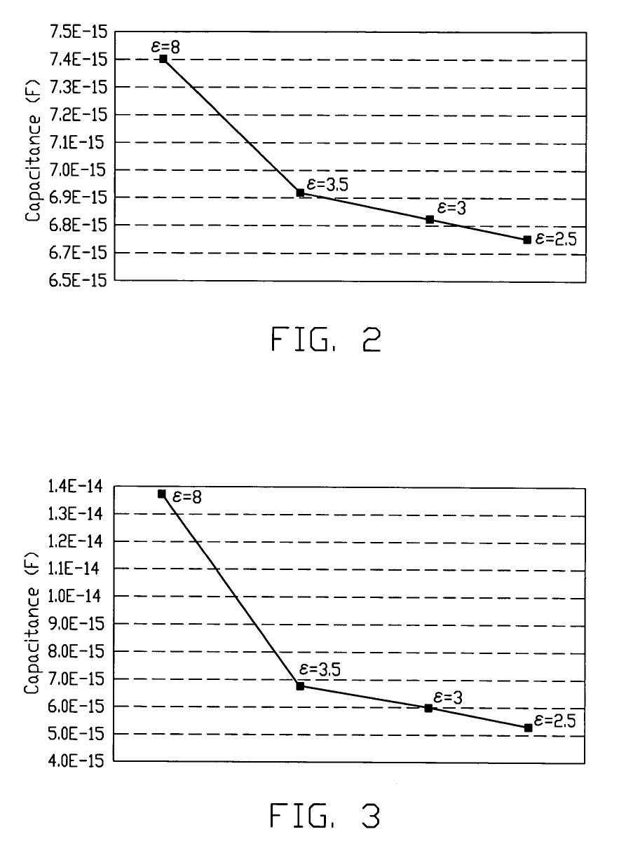

In one example, the liquid crystal layer 34 has a dielectric constant of 8 and a thickness of 4 μm. Each pixel electrode 324 has an area of 200 m². Each photospacer 36 is selected to have a dielectric constant in the range from 2.5˜3.5. A capacitance of the first coupling capacitor between the corresponding pixel electrode 324 and any one data line 322 changes as a value of the dielectric constant of the dielectric layer of the first coupling capacitor changes, and this relationship is illustrated in FIG. 2. In particular, the capacitance of the first coupling capacitor between the data line 322 and the pixel electrode 324 is reduced by 8.8% when a photospacer 36 having a dielectric constant of ε=2.5 is employed. That is, the photospacer 36 (having the low dielectric constant) in effect takes the place of part of the liquid crystal layer 36 (having the high dielectric constant) adjoining the pixel electrode 324, resulting in a reduction in the capacitance of the first coupling capacitor.

Additionally, in the same example, a capacitance of the second coupling capacitor between the corresponding common electrode 312 and the data line 322 changes as a value of the dielectric constant of the dielectric layer of the second coupling capacitor changes, and this relationship is illustrated in FIG. 3. In particular, the capacitance of the second coupling capacitor between the data line 322 and the common electrode 312 is reduced by 62.3% when the photospacer 36 having the dielectric constant of ε=2.5 is employed. That is, the photospacer 36 (having the low dielectric constant) in effect takes the place of part of the liquid crystal layer 36 (having the high dielectric constant) surrounding the common electrode 312, resulting in a marked reduction in the capacitance of the second coupling capacitor.

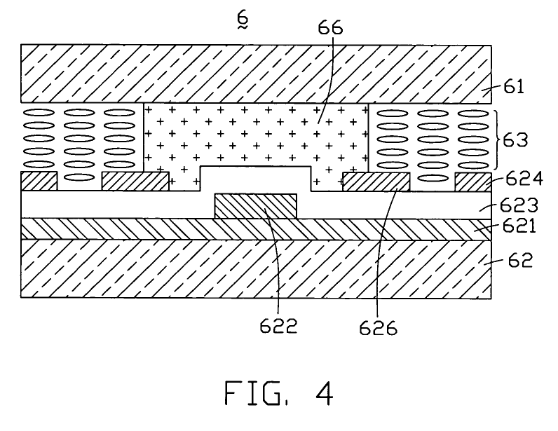

Referring to FIG. 4, this shows part of an LCD device 6 according to the second embodiment of the present invention. The LCD device 6 includes a first substrate 61, a second substrate 62, and a liquid crystal layer 63 interposed between the first and second substrates 61, 62. The second substrate 62 has an insulating layer 621, a plurality of data lines 622 (only one shown), a passivation layer 623, and a plurality of pixel electrodes 624 and a plurality of common electrodes 626 provided thereon. The common electrodes 626 and the pixel electrodes 624 are disposed at a same level on the passivation layer 623, wherein each common electrode 626 is generally disposed between two nearest pixel electrodes 624. A plurality of photospacers 66 is disposed between the first substrate 61 and the second substrate 62, to support and separate the first and second substrates 61, 62. Each photospacer 66 is disposed above and completely covers a corresponding one of the data lines 622, and also covers a part of each of two common electrodes 626 that correspond to the data line 622.

Any one of the data lines 622, one of the two corresponding pixel electrodes 624, the passivation layer 623 and the corresponding photospacer 66 may define a first coupling capacitor. The passivation layer 623 and the corresponding photospacer 66 arranged between the data line 622 and the corresponding pixel electrode 624 act as a dielectric layer of the first coupling capacitor. Further, any one of the data lines 622, one of the two corresponding common electrodes 626, the passivation layer 623 and the corresponding photospacer 66 may define a second coupling capacitor. The passivation layer 623 and the corresponding photospacer 66 arranged between the common electrode 626 and the data line 622 act as a dielectric layer of the second coupling capacitor.

In operation of the LCD device 6, different voltages may be applied on the pixel electrodes 624 and the data lines 622. Thus a parasitic electric field may be generated between any one of the pixel electrodes 624 and a corresponding data line 622. The parasitic electric field may adversely influence a display performance of the LCD device 6. Similarly, different voltages may be applied on the common electrodes 626 and the data lines 622. Thus a parasitic electric field may be also generated between any one of the common electrodes 626 and a corresponding data line 622. The parasitic electric field may adversely influence the display performance of the LCD device 6.

The first substrate 61, the second substrate 62 and the photospacers 66 may cooperatively define a plurality of separate spaces to accommodate liquid crystal molecules of the liquid crystal layer 63. That is, the locations of the photospacers 66 are predetermined. Therefore the photospacers 64 can uniformly separate the first and second substrates 61, 62, and increase a contrast ratio and a mechanical strength of the LCD device 6.

Further, the passivation layer 623 and the corresponding photospacer 66 arranged between the corresponding pixel electrode 624 and any one data line 622 act as the dielectric layer of the first coupling capacitor. The photospacers 66 are configured to have a lower dielectric constant than a dielectric constant of the liquid crystal layer 63. Accordingly, the corresponding photospacer 66 arranged between the corresponding pixel electrode 624 and the data line 622 can reduce the dielectric constant of the dielectric layer of the first coupling capacitor. Thus, the LCD device 6 has a lower first coupling capacitance between the data lines 622 and the pixel electrodes 624. This facilitates a reduction in crosstalk in operation of the LCD device 6, so that the LCD device 6 can provide better quality images.

Similarly, the passivation layer 623 and the corresponding photospacer 66 arranged between the corresponding common electrode 626 and any one data line 622 act as the dielectric layer of the second coupling capacitor. The photospacers 66 have the lower dielectric constant compared with the dielectric constant of the liquid crystal layer 63. Accordingly, the corresponding photospacer 66 arranged between the corresponding common electrode 626 and the data line 622 can reduce the dielectric constant of the dielectric layer of the second coupling capacitor. Thus, the LCD device 6 has a lower second coupling capacitance between the data lines 622 and the common electrodes 626. This facilitates a reduction in crosstalk in operation of the LCD device 6, so that the LCD device 6 can provide better quality images.

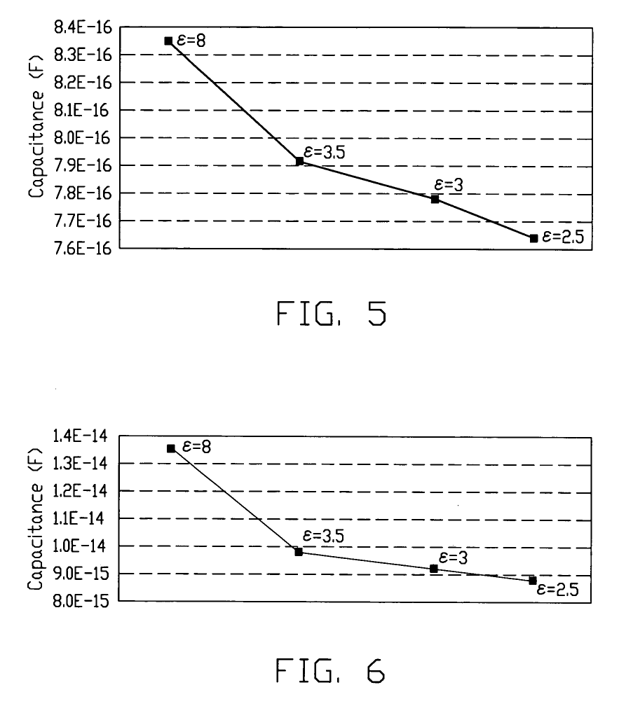

In one example, the liquid crystal layer 64 has a dielectric constant of 8 and a thickness of 4 μm. Each pixel electrode 624 has an area of 200 μm. Each photospacer 66 is selected to have a dielectric constant in the range from 2.5˜3.5. A capacitance of the first coupling capacitor between the corresponding pixel electrode 624 and any one data line 622 changes as a value of the dielectric constant of the dielectric layer of the first coupling capacitor changes, and this relationship is illustrated in FIG. 5. In particular, the capacitance of the first coupling capacitor between the data line 622 and the pixel electrode 624 and corresponding to the first combinative layer is reduced by 8.6% when a photospacer 66 having a dielectric constant of ε=2.5 is employed. That is, the photospacer 66 (having the low dielectric constant) in effect takes the place of part of the liquid crystal layer 64 (having the high dielectric constant) adjoining the pixel electrode 624, resulting in a reduction in the capacitance of the first coupling capacitor.

Additionally, in the same example, a capacitance of the second coupling capacitor between the corresponding common electrode 626 and the data line 622 changes as a value of the dielectric constant of the dielectric layer of the second coupling capacitor changes, and this relationship is illustrated in FIG. 6. In particular, the capacitance of the second coupling capacitor between the data line 622 and the common electrode 626 is reduced by 36.2% when the photospacer 66 having the dielectric constant of ε=2.5 is employed. That is, the photospacer 66 (having the low dielectric constant) in effect takes the place of part of the liquid crystal layer 64 (having the high dielectric constant) adjoining the common electrode 626, resulting in a marked reduction in the capacitance of the second coupling capacitor.

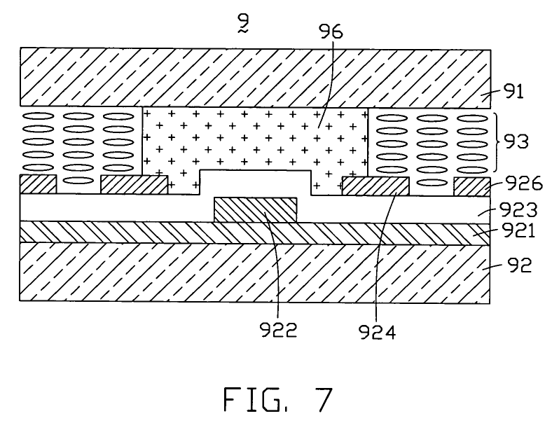

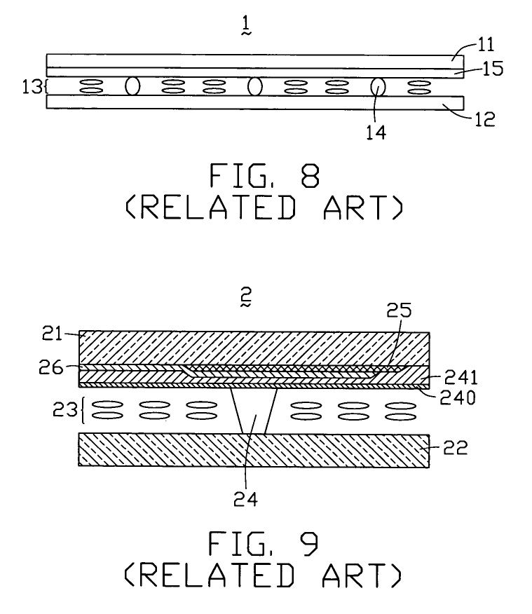

Referring to FIG. 7, this shows part of an LCD device 9 according to the third embodiment of the present invention. The LCD device 9 includes a first substrate 91, a second substrate 92, and a liquid crystal layer 93 disposed between the first and second substrates 91, 92. The second substrate 92 has an insulating layer 921, a plurality of data lines 922, a passivation layer 923, a plurality of pixel electrodes 924 and a plurality of common electrodes 926 provided thereon. The common electrodes 926 and the pixel electrodes 924 are disposed at a same level on the passivation layer 923, wherein each common electrode 926 is generally disposed between two nearest pixel electrodes 924. Each photospacer 66 is disposed above and covers a corresponding one of the data lines 622, and also covers a part of each of two common electrodes 626 that correspond to the data line 622. A plurality of photospacers 96 is disposed between the first substrate 91 and the second substrate 92, to support and separate the first and second substrates 91, 92. Each photospacer 96 is disposed above and completely covers a corresponding one of the data lines 922, and also covers a part of each of two pixel electrodes 924 that correspond to the data line 922.

As seen, the LCD device 9 is similar to the LCD device 6 of the second embodiment, except that the positions of the respective pixel and common electrodes are exchanged. The LCD device 9 has features and advantages similar to those described above in relation to the LCD device 6.

In any of the above-described embodiments, the photospacers may be made of transparent conductive material such as indium tin oxide (ITO) or indium zinc oxide (IZO). The insulating layer and the passivation layer may be made of SiNx (x selected from 2 or 4) or SiOx (x selected from 1 or 2). The pixel and common electrodes may be made of transparent conductive material such as ITO or IZO.

In another embodiment, for example, an LCD device can be provided, wherein the LCD device is similar to the LCD device 3 of the first embodiment, except that the positions of the pixel and common electrodes are exchanged. Such LCD device has features and advantages similar to those described above in relation to the LCD device 3. Further, in other various exemplary alternative embodiments, the photospacers may be arranged on the second substrate instead of the first substrate. Each photospacer may overlie or cover only a part of the corresponding data line. Each photospacer may cover the whole of the corresponding common electrodes or the whole of the corresponding pixel electrodes. Each photospacer may cover the whole of the corresponding data line and the whole of the corresponding common electrodes. Each photospacer may cover the whole of the corresponding data line and the whole of the corresponding pixel electrodes.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A liquid crystal display device, comprising:
a first substrate comprising a plurality of data lines thereon;
a second substrate opposite to the first substrate;
a liquid crystal layer interposed between the first and second substrates;
a plurality of photospacers disposed between the first and second substrates to support and separate the first and second substrates, the photospacers having a lower dielectric constant than the liquid crystal layer;
wherein at least one of the photospacers is disposed over a corresponding one of the data lines, and at least partly overlies the corresponding data line.

2. The liquid crystal display device according to claim 1, further comprising a plurality of pixel electrodes and common electrodes configured for generating an electric field in the liquid crystal layer.

3. The liquid crystal display device according to claim 2, wherein the pixel electrodes and the common electrodes are arranged on a same one of the first and second substrates.

4. The liquid crystal display device according to claim 3, wherein said at least one of the photospacers is also disposed over at least one of the common electrodes, and at least partly overlies said at least one of the common electrodes.

5. The liquid crystal display device according to claim 3, wherein said at least one of the photospacers is also disposed over at least one of the pixel electrodes, and at least partly overlies said at least one of the pixel electrodes.

6. The liquid crystal display device according to claim 2, wherein the pixel electrodes and the common electrodes are arranged on the first and second substrates respectively.

7. The liquid crystal display device according to claim 6, wherein said at least one of the photospacers is also disposed over at least one of the common electrodes, and at least partly covers said at least one of the common electrodes.

8. The liquid crystal display device according to claim 6, wherein said at least one of the photospacers is also disposed over at least one of the pixel electrodes, and at least partly covers said at least one of the pixel electrodes.

9. The liquid crystal display device according to claim 2, wherein the pixel electrodes are made of indium tin oxide or indium zinc oxide.

10. The liquid crystal display device according to claim 2, wherein the common electrodes are made of indium tin oxide or indium zinc oxide.

11. The liquid crystal display device according to claim 1, wherein said at least one of the photospacers completely overlies the corresponding data line.

12. The liquid crystal display device according to claim 1, wherein a dielectric constant of the photospacers is in the range from 2.5 to 3.5.

13. The liquid crystal display device according to claim 1, wherein the photospacers are made of indium tin oxide or indium zinc oxide.

14. A liquid crystal display device, comprising:
a first substrate comprising a plurality of data lines thereon;
a second substrate opposite to the first substrate;
a liquid crystal layer interposed between the first and second substrates;
a plurality of photospacers disposed between the first and second substrates to support and separate the first and second substrates, the photospacers having a lower dielectric constant than the liquid crystal layer;
wherein at least one of the photospacers is spaced from one of the data lines with a passivation layer in a vertical direction.

15. The liquid crystal display device according to claim 14, wherein said one of the photospacers is also positioned between a pair of pixel electrodes in a horizontal direction.

16. the liquid crystal display device according to claim 14, wherein said one of the photospacers defines a cavity which is compliant with a configuration of said one of the data lines and is occupied by the passivation layer.

17. A liquid crystal display device, comprising:
a first substrate comprising a plurality of data lines thereon;
a second substrate opposite to the first substrate;
a liquid crystal layer interposed between the first and second substrates;
a plurality of photospacers disposed between the first and second substrates to support and separate the first and second substrates, the photospacers having a lower dielectric constant than the liquid crystal layer;
wherein at least one of the photospacers is recessed in a vertical direction with therein a cavity which is occupied by a passivation layer.

18. The liquid crystal display device according to claim 17, wherein said cavity is at least partially aligned with a data line in a vertical direction.
